(19) United States
(12) Patent Application Publication
(10) Pub. No.: US 2008/0104582 A1
(43) Pub. Date: May 1, 2008

(54) SYSTEM FOR PROVIDING SOFTWARE RELATED INFORMATION, APPARATUS FOR PROCESSING DESCRIPTION DATA, AND SOFTWARE COMPONET

(75) Inventors: Ikuko Osajima, Yokohama-shi (JP); Nobuyuki Ikeda, Tokyo (JP); Hirotaka Toya, Yokohama-shi (JP); Katsumasa Jin, Kawasaki-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/844,696

(22) Filed: Aug. 24, 2007

(30) Foreign Application Priority Data
Nov. 1, 2006 (JP) 2006-297642

(51) Int. Cl. G06F 9/44

(52) U.S. Cl. 717/162

(57) ABSTRACT

A system for providing software related information is constructed from a client terminal to be used by a software developer and a description data providing server that provides description data for describing how to use a software component to the client terminal via a communication network. The software component is utilized for software development. The description data of the software component is stored in a description data database so as to be associated with the software component. The description data providing server includes the description data database. Link data indicating storage location information of the description data in the description data database is created. The created link data is set to the software component. The software component and the description data are managed so as to be associated with each other.

### CROSS-REFERENCE TO RELATED APPLICATIONS

This application is based upon and claims the benefit of priority from the prior Japanese Patent Application No. 2006-297642, filed on Nov. 1, 2006, the entire contents of which are expressly incorporated herein by reference in its entirety.

### BACKGROUND OF THE INVENTION

1. Field of the Invention

The present invention relates to a system for providing software related information constructed from a client terminal to be used by a software developer and a description data providing server that provides description data for describing how to use a software component utilized for software development to the client terminal via a communication network. The present invention also relates to an apparatus for processing description data, and a software component.

2. Description of the Prior Art

Recently, in order to improve development efficiency of software, an attempt to improve the development efficiency has been made by utilizing so-called software components into which software is divided to be utilized to develop each function of the software, and comprehensively creating the software through the development of each function of the software.

For example, a technique has been proposed that specifications and programs common to software belonging to a domain are accumulated in a library as a frame work of the domain and the frame work of the domain is utilized when to develop new software, thereby improving development efficiency (for example, see JP-A 7-11766 (KOKAI))

Further, a technique has been proposed that a software component required for software development and another software component interrelated with the software component are searched and these software components are precisely embedded into an embedded position in consideration of start timing of each component, thereby improving development efficiency (for example, see JP-A 6-119153 (KOKAI)).

In this regard, in the case where software is developed using such software components, a software developer is first required to understand a method of utilizing the software components to be utilized. For this reason, the software developer has to grasp the method of utilizing the software components using description (or documentation) in which the method of utilizing the software components and the like are described.

In JP-A 7-11766 (KOKAI) and JP-A 6-119153 (KOKAI) described above, no mechanism that specification (that is, description) of software component is associated with a target (that is, the software component) of the specification is disclosed. Thus, there has been a problem that the costs are increased because identification of a description that the software developer wants to utilize and correspondence between software component and the description become complicated in the case where the software component becomes a large scale and the amount of description thereby becomes an enormous amount.

### SUMMARY OF THE INVENTION

One aspect of the present invention is directed to a system for providing software related information. The system is constructed from a client terminal to be used by a software developer and a description data providing server that provides description data for describing how to use a software component to the client terminal via a communication network. The software component is utilized for software development. The system of the present invention includes a description data database for storing the description data therein. In this case, the server is provided with the description data database. The system also includes a description data storage section for storing the description data of the software component to the description data database so that the description data is associated with the software component. The system also includes a link data creator for creating link data indicating storage location information of the description data in the description data database. The system also includes a link setter for setting the link data created by the link data creator to the software component.

Another aspect of the present invention is directed to an apparatus for processing description data for describing how to use a software component. The description data is provided from a description data providing server via a communication network. The software component is utilized for software development. The apparatus of the present invention includes a description data storage section for storing the description data of the software component in a description data database of the description data providing server so that the description data is associated with the software component. The apparatus also includes a link data creator for creating link data indicating storage location information of the description data in the description data database. The apparatus also includes a link setter for setting the link data created by the link data creator to the software component.

Still another aspect of the present invention is directed to a software component storing program codes for causing a computer to develop software. The software component of the present invention includes a link data storage section in which link data is stored, the link data indicating storage location information of description data, the description data being stored in a description data database so that the description data is associated with the software component. The software component also includes a description data obtaining section for obtaining the description data from the description data database by referring to the link data.

### BRIEF DESCRIPTION OF THE DRAWINGS

The above and other objects, features and advantages of the present invention will become apparent from the following description of the preferred embodiments with reference to the accompanying drawings, wherein:

FIG. 1 is a block diagram that shows an example of a configuration of a software related information providing system according to an embodiment of the present invention;

FIG. 2 is a schematic diagram that shows an example of an internal structure of each of a client terminal and a description data providing server;

FIG. 3 is a flowchart that shows an example of a description data storing process; and

FIG. 4 is a flowchart that shows an example of a description data obtaining process.

### DESCRIPTION OF THE PREFERRED EMBODIMENT

Preferred embodiments of a software related information providing system, an apparatus for processing description data and a software component according to the present invention will now be described in detail with reference to the appending drawings.

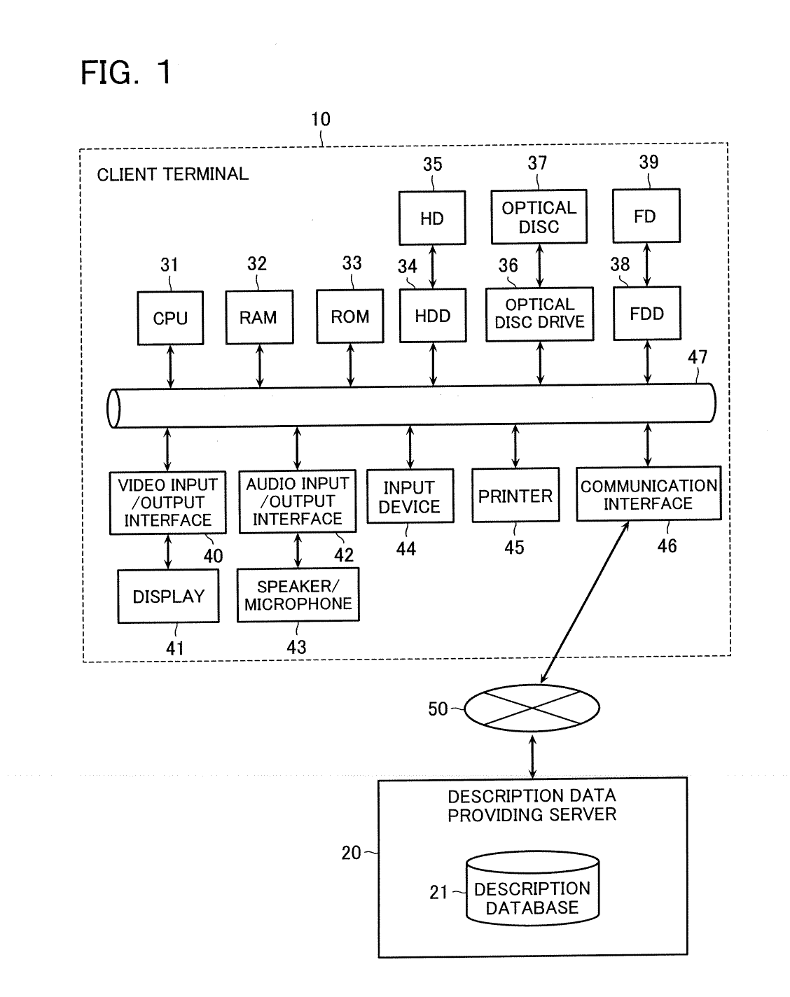

FIG. 1 is a block diagram that shows an example of a configuration of a software related information providing system according to an embodiment of the present invention. As shown in FIG. 1, a software related information providing system is constructed from a client terminal 10 and a description data providing server 20. The client terminal 10 and the description data providing server 20 are connected to each other via a communication network 50 such as the Internet. In this case, any number of client terminals 10 and/or any number of description data providing servers 20 may be provided in the software related information providing system.

The client terminal 10 is constructed from an information processing apparatus such as a personal computer, a workstation, and a portable information terminal. In the present embodiment, the client terminal 10 includes, for example, a central processing unit (CPU) 31, a random access memory (RAM) 32, a read only memory (ROM) 33, a hard disk drive (HDD) 34, a hard disk (HD) 35, an optical disc drive 36, an optical disc 37, a flexible disk drive (FDD) 38, and a flexible disk (FD) 39.

In addition, the client terminal 10 further includes, for example, a video input/output interface (I/F) 40, a display 41, an audio input/output interface (I/F) 42, a speaker/microphone 43, an input device 44, a printer 45 and a communication interface (I/F) 47. A software component used to develop various functions of software when to work software development is to be started and executed in the client terminal 10. In this regard, each of the components 31 to 46 described above of the client terminal 10 is connected to a bus 47.

The CPU 31 controls the whole of the client terminal 10 by executing predetermined processing, and realizes each function of a software component. The RAM 32 is mainly used as a work area for the CPU 31 by rewritably storing variable data. The RAM 32 may be a volatile memory in which stored data is erased by power OFF, or a non-volatile memory in which stored data is retained by means of backup with a battery or the like.

Various control programs for the client terminal 10 are stored in the ROM 33. Data stored in the ROM 33 can be rewritten by, for example, operations of a user of the client terminal 10, but cannot be rewritten by power OFF. In this regard, various control programs may be stored in a storage device or a storage media such as the HD 35 and the optical disc 37 other than ROM 33.

The CPU 31 obtains description data of the software component from the description data providing server 20 to the client terminal 10 via the communication network 50 in accordance with a description data obtaining program of the software component of the present embodiment, for example.

Further, in accordance with a description data obtaining program of the software component of the present embodiment, for example, the CPU 31 stores the description data of the software component to the description data providing server 20 via the communication network 50. The CPU 31 also sets link data indicating storage location information of the stored description data to the software component by embedding. In this case, the term “description data” means data that indicates a document in which various explanations relating to usage of the software component are described. A constituent unit of the document may be constituted from either a single document or a plurality of documents.

The HDD 34 executes control of reading out or writing data from or to the HD 35 in accordance with control commands of the CPU 31. In this regard, in the case where programs and the like to realize each function of the software component are stored in a magneto-optical disc (MO), various memory cards or the like, for example, the client terminal 10 may include a dedicated drive capable of at least reading out stored data therefrom in place of the HDD 34 or together with the HDD 34.

The HD 35 is used to record (or store) various control programs and various data so that the CPU 31 can read out them therefrom. The HD 35 accepts writing of data by the HDD 34 and then records the written data so as to be non-volatile. The optical disc drive 36 executes reading out and/or writing data to the optical disc 37 in accordance with control commands of CPU 31. The optical disc 37 is a storage medium capable of detachably inserting the optical disc drive 36. Thus, the optical disc 37 has portability. The FDD 38 executes reading out and/or writing data to the FD 39 in accordance with control commands of the CPU 31. The FD 39 is a detachable storage medium to accept writing of data by the FDD 38 and to record the written data so as to be non-volatile.

The video input/output interface 40 is connected to the display 41. More specifically, the video input/output interface 40 is constructed from a graphic controller executing control of the whole display 41, a buffer memory temporally storing image data, a control IC controlling display of the display 41 and the like, for example.

The display 41 is constructed from a display device such as a TFT liquid crystal display, a CRT, an organic EL display, a plasma display, for example. Various kinds of information such as icons, cursors, menus, windows, characters and images are displayed in the display 41. Further, when the CPU 31 executes a description data outputting program (will be described later), a document of the description data is displayed in the display 41.

The audio input/output interface 42 is connected to the speaker/microphone 43 that includes a speaker for outputting audio and a microphone for inputting audio. Audio received by the speaker/microphone undergoes A/D conversion in the audio input/output interface 42, for example. Further, audio is also outputted from the speaker/microphone 43. In the case where the CPU 31 executes the description data outputting program, audio representing contents of a document of description data may be outputted from the speaker/microphone 43.

The input device 44 is constructed from a keyboard, a mouse, a touch panel, a joystick, a track ball, a push-button switch, or the like. The input device 44 outputs input information inputted by means of operations of the user to the CPU 31. The printer 45 prints out various kinds of information on a printing recording medium such as a paper in accordance with control commands of the CPU 31. Further, in the case where the CPU 31 executes the description data outputting program, a document of the description data may be printed out from the printer 45.

The communication interface 46 is connected to the communication network 50 via a communication cable (not shown in the drawings), for example. The communication interface 46 is constructed from a network board functioning as an interface between the client terminal 10 and the communication network 50. Further, the communication interface 46 may be constructed from a communication module capable of wireless communication or the like. The communication interface 46 executes transmission/reception of various kinds of information such as description data between the client terminal 10 and the description data providing server 20 via the communication network 50. Moreover, the communication interface 46 executes transmission/reception of various kinds of information between the client terminal 10 and other client terminal connected to the client terminal 10 via a local network such as a LAN (not shown in the drawings).

On the other hand, the description data providing server 20 is constructed from an information processing apparatus such as a WWW server. The description data providing server 20 is managed by a system administrator of the software related information providing system. The structure similar to the internal structure of the client terminal 10 described above can be adopted as an internal structure of the description data providing server 20. Thus, detailed description for the description data providing server 20 is omitted. The description data providing server 20 may be designed to work in a distributed manner like a peer-to-peer (P2P) server. Alternatively, the description data providing server 20 may be integrated into any client terminal (such as the client terminal 10). The description data providing server 20 includes a description data database (DB) 21 for storing description data. The description data database 21 may be incorporated in the description data providing server 20, or may be provided outside the description data providing server 20 as another component.

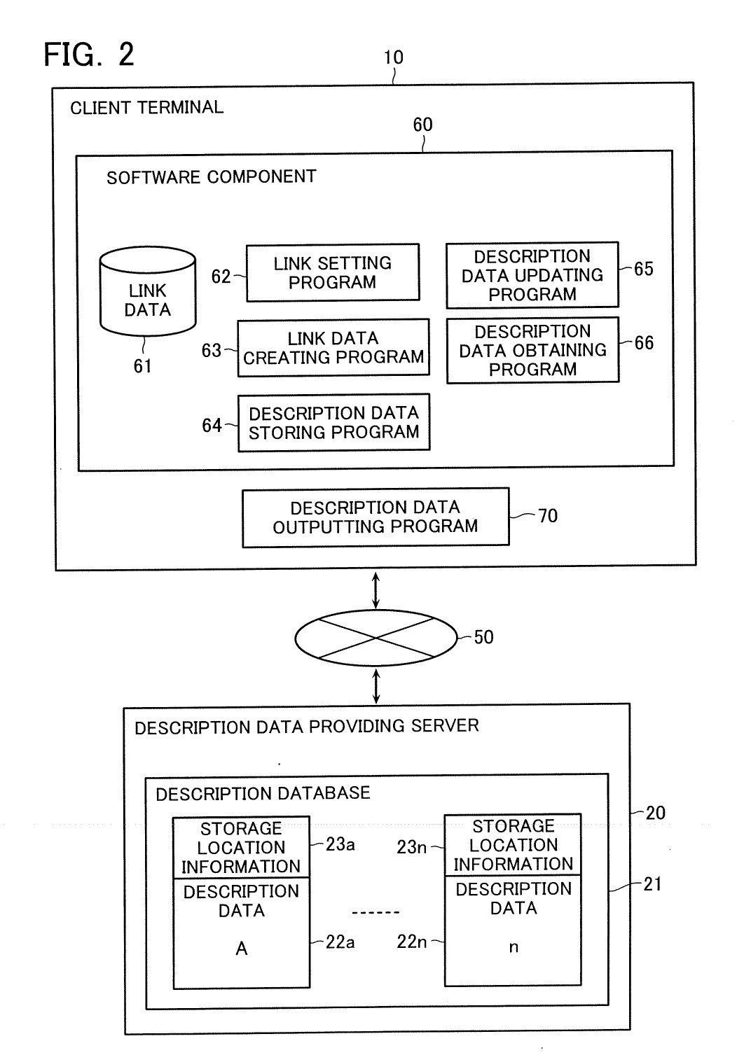

Next, an internal structure of each of the client terminal 10 and the description data providing server 20 in the software related information providing system will be described. FIG. 2 is a schematic diagram that shows an example of an internal structure of each of the client terminal 10 and the description data providing server 20. In the client terminal 10, when the CPU 31 described above reads in a control program for the software component from the ROM 33 or the HD 35 to execute the control program, a software component 60 starts. Further, in the client terminal 10, the CPU 31 reads in a description data outputting program 70 from the ROM 33 or the HD 35 to execute the description data outputting program 70. The CPU 31 outputs description data 22a obtained from the description data providing server 20 to realize a process that the description data 22a is displayed in the display 41, a process that audio corresponding to the description data 22a is outputted from the speaker/microphone 43, and/or a process that the description data 22a is printed out from the printer 45. In this regard, since the description data outputting program 70 is a program to execute a process relating to output of the description data, the description data outputting program 70 may be provided in other client terminal connected to the client terminal 10 via a local network, or equipped in the printer 45.

The software component 60 is constituted so as to include link data 61, a link setting program 62, a link data creating program 63, a description data storing program 64, a description data updating program 65 and a description data obtaining program 66. Further, the description data providing server 20 is configured so as to include the description data database 21.

In this regard, the software component 60 is utilized for software development (more specifically, utilized to develop each function of software), for example. The software component 60 is constituted so that a component usage method, a description data obtaining method and the like can be executed by executing the respective programs 62 to 66 described above and the like. The component usage method is an external interface utilized when using a predetermined function realized by the software component 60. The description data obtaining method is an external interface utilized when obtaining description data associated with the software component 60. The software component 60 has a structure, to which the link data 61 indicating the storage location information 23a to 23n of the description data 22a to 22n stored in the description data database 21 are set, therein. Each of the methods is realized by means of a known individual method of a language interface that the client terminal 10 can utilize, such as C++®, Java®, and C#®.

The link setting program 62 realizes a process to set the link data 61 created by realizing the link data creating program 63 to the software component 60 by embedding. The link data creating program 63 realizes a process to create the link data 61 indicating the storage location information (for example, the storage location information 23a) of the description data (for example, the description data 22a) in the software component 60 on the basis of the storage location information 23a to 23n of the description data 22a to 22n in the description data database 21 of the description data providing server 20.

The description data storing program 64 realizes a process to store the description data 22a of the software component 60 (that is, the description data 22a applied to the software component 60) in the description data database 21 with which the description data providing server 20 is provided so as to be associated with the software component 60.

The description data updating program 65 realizes a process to update the contents of the description data 22a stored in the description data database 21 of the description data providing server 20 by executing the description data storing program 64. The description data obtaining program 66 realizes a process to refer to the link data 61 set in the software component 60 and to obtain the description data 22a with the storage location information 23a indicated by the link data 61 from the description data database 21 of the description data providing server 20 by executing the link setting program 62.

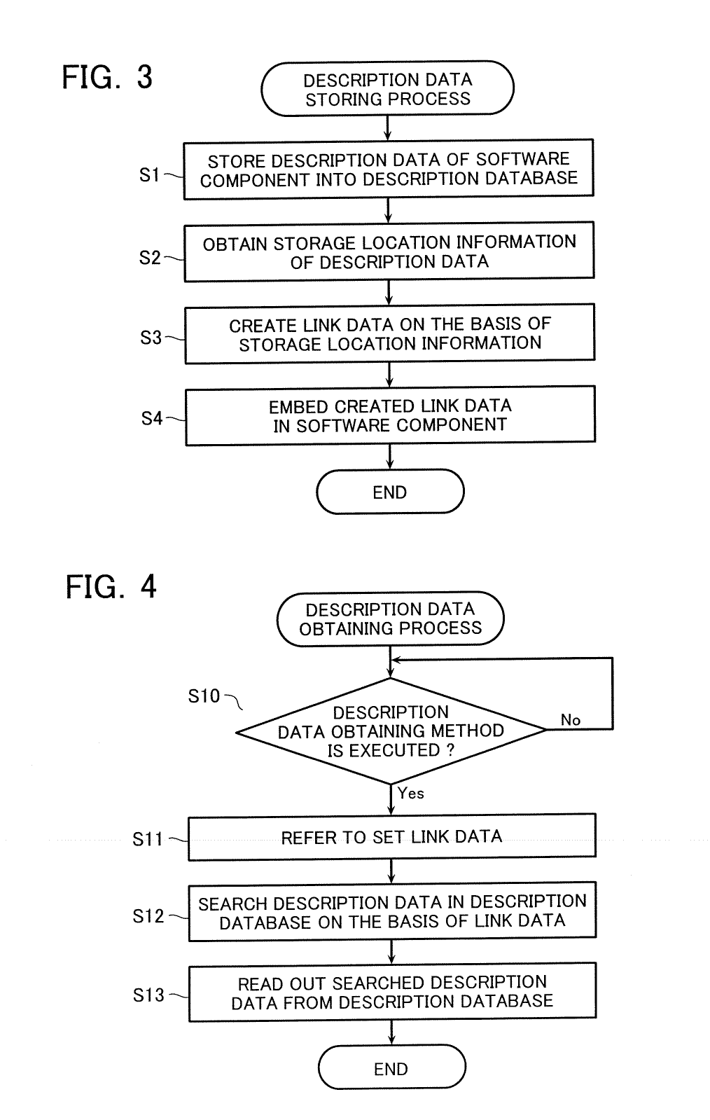

Next, a description data storing process in the software related information providing system that is realized by executing the link setting program 62, the link data creating program 63 and the description data storing program 64 of the software component 60 described above at the client terminal 10 will be described. FIG. 3 is a flowchart that shows an example of a description data storing process.

A system administrator or the like of the software related information providing system first causes the client terminal 10 to execute the description data storing program 64 of the software component 60 to be utilized at the client terminal 10, whereby the client terminal 10 accesses the description data providing server 20 to store the description data 22a of the software component 60 utilized at the client terminal 10 into the description data database 21 of the description data providing server 20 (Step S1). In this case, the system administrator or the like may directly manipulate the description data providing server 20 to store the description data 22a in the description data database 21.

Subsequently, the client terminal 10 executes, for example, the link data creating program 63 of the software component 60 utilized at the client terminal 10 to obtain the storage location information 23a of the description data 22a in the description data database 21 from the description data providing server 20 (Step S2). The client terminal 10 creates the link data 61 of the description data 22a in accordance with the obtained storage location information 23a (Step S3).

Finally, the client terminal 10 executes the link setting program 62 of the software component 60 to embed the link data 61 created at Step S3 in the software component 60 (Step S4). A series of processes in this flowchart is then terminated. Execution of such a storage process allows the description data 22a to be stored in the description data database 21 after associating the description data 22a with the software component 60 by means of the link data 61 and the storage location information 23a. For this reason, the description data 22a required by the software component 60 can be unambiguously associated with the software components among the plurality of description data 22a to 22n in the description data database 21.

Namely, the description data 22a in the description data database 21 can be utilized by setting the link data 61 to the single software component 60. Thus, for example, even in the case where a plurality of software components are respectively utilized in a plurality of client terminals and a plurality of description data are stored in the description data database 21, it is possible to manage the software components and the description data so as to associate the respective software component with the corresponding description data. Further, it is possible to manage the description data 22a so as to be associated with the software components unambiguously by setting the link data 61 of the description data 22a to the software component 60. Thus, there is no problem even in the case where the software component 60 and the description data 22a are changed or updated.

Next, a description data obtaining process in the software related information providing system realized by executing the description data obtaining program 66 of the software component 60 described above at the client terminal 10 will be described. FIG. 4 is a flowchart that shows an example of a description data obtaining process.

In the case where the client terminal 10 first receives, from a user such as a software developer, input information for instructing a description data obtaining method to be executed after the user starts the software component 60 at the client terminal 10, the client terminal 10 waits until the description data obtaining method is executed as an external interface to be utilized when to obtain the description data 22a associated with the software component 60 (“No” at Step S10). When the description data obtaining method is executed (“Yes” at Step S10), the client terminal 10 refers to the link data 61 set therein (Step S11).

Subsequently, on the basis of the referred link data 61, the client terminal 10 searches for the description data 22a including the storage location information 23a corresponding to the link data 61 among the description data 22a to 22n stored in the description data database 21 of the description data providing server 20 (Step S12).

Finally, the client terminal 10 reads in the searched description data 22a from the description data database 21 of the description data providing server 20 to obtain the searched description data 22a at the client terminal 10 side (Step S13). A series of processes in this flowchart is then terminated. In this regard, by executing the description data outputting program 70 at the client terminal 10 after obtaining the description data 22a, information included in the description data 22a may be outputted to be displayed on the display 41. This allows the user to grasp the contents of the information by viewing. By executing such an obtaining process, the user can obtain and utilize the description data of the used software component. In addition, since there is no need to equip special environment in the software related information providing system by using the description data, it is possible to improve development efficiency while reducing the costs.

Compared with a system in which help information is separately prepared in application software like an online help function for providing help information to a user via a communication network, which is realized by Microsoft Office®, for example, according to the software related information providing system according to the present embodiment, a problem that time and/or difficulty is required to search reference of help information in any function of application software and a problem such as an error that reference cannot be searched hardly occur.

Further, although help information is separately prepared for application software like the online help function, the help information for each function of the application software (that is, for each software component) is not managed. Thus, compared with application software in which help information is changed by human work as countermeasures when each component is changed, the software related information providing system according to the present embodiment has high management efficiency, and no error occurs.

Moreover, in the software related information providing system according to the present embodiment, the user can utilize the description data readily without equipping a special environment compared with a system in which help information cannot be utilized if there is no development environment where tools are installed, like an online help function for providing help information to a user via a communication network, which is realized by Microsoft Visual Studio®, for example.

As described above, according to the embodiment of the present embodiment, the description data of the software component is stored in the description data database with which the server is provided so that the description data is associated with the software component; the link data indicating storage location information of the description data in the description data database is created; and the created link data is set to the software component. Thus, it is possible to manage the description data so that the software component is associated with the description data. This makes it possible to improve development efficiency while reducing costs for software development.

Further, according to the embodiment of the present embodiment, the client terminal 10 side refers to the link data set to the software component; and the client terminal 10 obtains the description data from the description data database of the description data providing server 20. Thus, the user is allowed to utilize the description data corresponding to the software component readily.

Moreover, according to the embodiment of the present embodiment, the obtained description data is outputted at the client terminal 10 side so as to be displayed or printed out. Thus, the user is allowed to view the description data corresponding to the software component readily.

Furthermore, according to the embodiment of the present embodiment, the description data stored in the description data database so that the description data is associated with the software component is updated at the description data providing server 20. Thus, even in the case where the contents of the software component or the description data are changed, the user is allowed to utilize the description data corresponding to the software component readily.

In this regard, although it is not particularly referred to in the embodiment described above, a plurality of software components may be started at one client terminal, and such a software component is not limited to one utilized for software development.

Further, in the embodiment described above, the system for providing software related information is constructed so that the client terminal is connected to the description data providing server via the communication network. However, the system may be constructed so that the client terminal has the functions of the description data providing server, or the description data providing server is installed in a local network such as a LAN.

Additional advantages and modifications will readily occur to those skilled in the art. Therefore, the invention in its broader aspects is not limited to the specific details or representative embodiments shown and described herein. Accordingly, various modifications may be made without departing from the spirit or scope of the general inventive concept as defined by the appended claims and their equivalents.

What is claimed is:

1. A system for providing software related information, the system being constructed from a client terminal to be used by a software developer and a description data providing server that provides description data for describing how to use a software component to the client terminal via a communication network, the software component being utilized for software development, the system comprising:
a description data database for storing the description data therein, the server being provided with the description data database;
a description data storage section for storing the description data of the software component to the description data database so that the description data is associated with the software component;
a link data creator for creating link data indicating storage location information of the description data in the description data database; and
a link setter for setting the link data created by the link data creator to the software component.

2. The system according to claim 1, further comprising:
a description data updater for updating the description data stored in the description data database.

3. The system according to claim 1, further comprising:
a description data obtainer for obtaining the description data from the description data database by referring to the link data set to the software component by the link setter.

4. The system according to claim 3, further comprising:
a description data updater for updating the description data stored in the description data database.

5. The system according to claim 1, further comprising:
a description data output section for outputting the description data obtained by the description data obtainer.

6. The system according to claim 5, further comprising:
a description data updater for updating the description data stored in the description data database.

7. An apparatus for processing description data for describing how to use a software component, the description data being provided from a description data providing server via a communication network, the software component being utilized for software development, the apparatus comprising:
a description data storage section for storing the description data of the software component in a description data database of the description data providing server so that the description data is associated with the software component;
a link data creator for creating link data indicating storage location information of the description data in the description data database; and
a link setter for setting the link data created by the link data creator to the software component.

8. The apparatus according to claim 7, further comprising:
a description data updater for updating the description data stored in the description data database.

9. The apparatus according to claim 7, further comprising:
a description data obtainer for obtaining the description data from the description data database by referring to the link data set to the software component by the link setter.

10. The apparatus according to claim 9, further comprising:
a description data updater for updating the description data stored in the description data database.

11. The apparatus according to claim 7, further comprising:
a description data output section for outputting the description data obtained by the description data obtainer.

12. The apparatus according to claim 11, further comprising:
a description data updater for updating the description data stored in the description data database.

13. A software component storing program codes for causing a computer to develop software, the software component comprising:
a link data storage section in which link data is stored, the link data indicating storage location information of description data, the description data being stored in a description data database so that the description data is associated with the software component; and
a description data obtaining section for obtaining the description data from the description data database by referring to the link data.

14. The software component according to claim 13, further comprising:
a description data updating section for updating the description data stored in the description data database.

15. The software component according to claim 13, further comprising:
a description data output section for outputting the description data obtained by the description data obtaining section.

16. The software component according to claim 15, further comprising:
a description data updating section for updating the description data stored in the description data database.

17. The software component according to claim 13, further comprising:
a link data creating section for creating the link data; and
a link setting section for setting the link data created by the link data creating section to the software component.

18. The software component according to claim 17, further comprising:
a description data updating section for updating the description data stored in the description data database.

19. The software component according to claim 17, further comprising:
a description data output section for outputting the description data obtained by the description data obtaining section.

20. The software component according to claim 19, further comprising:
a description data updating section for updating the description data stored in the description data database.
